(19) United States
(12) Patent Application Publication
(10) Pub. No.: US 2024/0026846 A1
(43) Pub. Date: Jan. 25, 2024

(54) POWER SUPPLY DEVICE AND METHOD FOR VEHICLE EMERGENCY STARTING

(71) Applicant: NINGBO CARSTEL MANUFACTURING CO., LTD., Ningbo, Zhejiang (CN)

(72) Inventor: Lei ZHANG, Ningbo (CN)

(21) Appl. No.: 17/292,655

(22) PCT Filed: Apr. 22, 2021
(86) PCT No.: PCT/CN2021/088883

§ 371 Date: May 10, 2021

(30) Foreign Application Priority Data
Apr. 19, 2021 (CN) 202110415562.2

(51) Int. Cl. F02N 11/12; B60R 16/033; G08B 21/16; H02J 7/34

(52) U.S. Cl. CPC F02N 11/12; B60R 16/033; G08B 21/16; H02J 7/342

(57) ABSTRACT

The invention provides a power supply device for vehicle emergency starting, which includes a built-in battery, a protection switch and a control unit, wherein the control unit is configured to receive vehicle ignition signal; and the control unit is configured to close the protection switch when the vehicle ignition signal is received after the power supply device is connected to accumulator of the vehicle.

### FIELD OF THE INVENTION

This invention relates to vehicle emergency starting, in particular to a power supply device and a method for vehicle emergency starting.

### DESCRIPTION OF THE PRIOR ART

The starting system is used for starting a gasoline or diesel engine and drives the stationary engine into working state. At present, almost all the automobile and some small agricultural machinery adopt a starting system of electric power, in which the accumulator is the most important one of all the components.

Start-up of an engine requires the accumulator to provide a large starting current, typically between 200-800 Amps. Accumulators, however, suffer from poor performance at high-rate and low-temperature discharges, and thus result in a situation in which the engine cannot be started because a sufficiently large starting current cannot be provided. In addition, due to the degradation of the performance of the accumulator, the output voltage of the battery changes violently in the starting process, so that the starting system will be powered down, and the engine cannot be started normally. In this case, an emergency starting device housing a battery, generally a lead-acid battery or a lithium battery, is to be applied. The two output ends of the emergency starting device are connected with the two output ends of the accumulator of the starting system, so that an alternative battery is used for outputting starting current and starting the engine. Nonetheless, the existing emergency starting devices tend to be bulky and the life of its battery is only 2-3 years, just like that of the automobile accumulators. Furthermore, when the temperature is low or the power is deficient, the emergency starting device cannot effectively start the automobile. Regular maintenance is required to keep the emergency starting device in function.

A common emergency starting device, as shown in FIG. 1, usually has a built-in battery and a pair of clips 3 which can be clamped to the positive and negative terminals of the automobile accumulator 4. When the built-in control unit detects the correct voltage on the clips 3, it means the connection polarity of the clips and the accumulator is correct, then the protection switch 2 is closed. If the automobile ignition switch 5 is closed at this time, the vehicle will be started.

However, when the accumulator is in the condition of loss of capacity, its voltage is relatively low, between 4 V and 12 V, while the voltage of the voltage is usually high and between 13 V and 17 V. After closing protection switch 2, the battery of the emergency starting device and the automobile accumulator are connected in parallel. The battery of the emergency starting device starts to discharge to the automobile storage battery as soon as the protection switch is closed. Due to the fact that the capacity of the emergency starting device is far smaller than that of the automobile accumulator and the voltage of the emergency starting device is higher than that of the automobile accumulator, the voltage of the emergency starting device will be rapidly pulled down by the automobile accumulator, so that the discharging voltage level is lowered, and the performance of the starting device is not good enough.

### SUMMARY OF THE INVENTION

In view of the defects of the prior art, the invention aims to solve the technical problem by providing a power supply device and method for vehicle emergency starting.

For this purpose, the invention first provides a power supply device for vehicle emergency starting, which includes a built-in battery, a protection switch and a control unit, wherein the control unit is configured to receive vehicle ignition signal; and the control unit is configured to close the protection switch when the vehicle ignition signal is received after the power supply device is connected to accumulator of the vehicle.

In a preferred embodiment of the invention, the vehicle ignition signal is derived from a sudden change of voltage or current at the terminals of the accumulator of the vehicle.

In another preferred embodiment of the present invention, wherein the vehicle ignition signal is derived from vehicle central control system.

In another preferred embodiment of the invention, the power supply device comprises a body and a handle; a screen is obliquely disposed under the handle portion on the body.

In another preferred embodiment of the invention, a CO sensor and a CO alarm device are provided on the handle.

In another preferred embodiment of the invention, a warning triangle of light composed of yellow light-emitting diodes is provided on the front face of the body.

Secondly, the invention provides a method for vehicle emergency starting comprising steps: connecting the accumulator of the vehicle to a power supply device, wherein the power supply device includes a built-in battery, a protection switch and a control unit; igniting the vehicle; the control unit closing the protection switch when it receives vehicle ignition signal, thereby the built-in battery supplying power to the accumulator to start the vehicle.

In a preferred embodiment of the invention, the vehicle ignition signal is derived from a sudden change of voltage or current at the terminals of the accumulator of the vehicle.

In another preferred embodiment of the present invention, wherein the vehicle ignition signal is derived from vehicle central control system.

In another preferred embodiment of the invention, the power supply device comprises a body and a handle; a screen is obliquely disposed under the handle portion on the body; a CO sensor and a CO alarm device are provided on the handle; a warning triangle of light composed of yellow light-emitting diodes is provided on the front face of the body.

The protection switch of the present invention is closed only when the engine is ignite, thereby avoiding the failure possibility of emergency starting caused by an advanced battery discharge to the accumulator.

Referencing now to the figures, conceptions, specific structures and technical effect, the present invention will be further described to provide a thorough understanding of the purpose, features, and effects of the invention.

### BRIEF DESCRIPTION OF THE DRAWINGS

FIG. 1 provides a circuit schematic of an emergency starting device in the prior art.

FIG. 2 provides a circuit schematic of one embodiment of a power supply device for vehicle emergency starting as contemplated herein.

FIG. 3 provides a perspective view of one embodiment of a power supply device for vehicle emergency starting as contemplated herein.

FIG. 4 provides a side view of one embodiment of a power supply device for vehicle emergency starting as contemplated herein.

FIG. 5 provides a perspective view of another embodiment of a power supply device for vehicle emergency starting as contemplated herein.

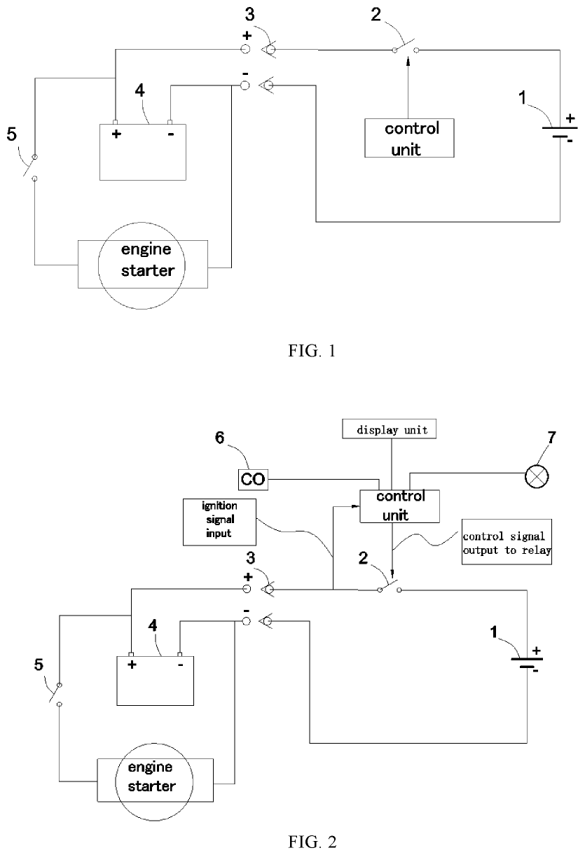

### DETAILED DESCRIPTION OF THE PREFERRED EMBODIMENTS

A plurality of preferred embodiments of the present invention are described below with reference to the drawings, which makes its technical content more clear and convenient to understand. The present invention may be embodied in many different forms of embodiments, and the scope of protection of the present invention is not limited to the embodiments set forth herein.

A circuit schematic of one embodiment of a power supply device for vehicle emergency is shown as FIG. 2. The emergency starting power supply device includes a built-in battery 1, two output ends of the built-in battery 1 are connected to the positive and negative poles of the vehicle accumulator 4 through electric connecting pieces such as clips 3, the emergency starting power supply device further includes a control unit and a protection switch 2. The control unit can receive vehicle ignition signal, and when the control unit receives a vehicle ignition signal, the protection switch 2 is closed, thereby the built-in battery 1 supplies power to the accumulator 4 to start the vehicle.

When the ignition switch 5 is closed, the voltage of accumulator 4 will rapidly drop while its current rapidly increasing due to its discharging to the engine starter. The control unit receives the suddenly changed voltage or current signal as the ignition signal. For example, if it is detected that the voltage drop speed is greater than 2V/sec, the control unit will give an instruction to the protection switch 2 to close. For example, a Hall current sensor is sleeved on the starting cable of an automobile and the current on the cable is detected. When it senses that the current suddenly rises, for example, when the rising rate of the current is not less than 20A/s, the control unit will send a control signal to the protection switch 2.

In other embodiments, the ignition signal may also be a signal transmitted by the vehicle central control system to the control unit when the engine is started.

In addition, when the air conditioner is turned on and the vehicle is in an underground parking garage for a long period of time, there is a risk of carbon monoxide poisoning for the people in the vehicle. In a further embodiment, an emergency start power supply device according to the present invention is also provided with a CO detection function. The control unit may also receive the signal of the CO sensor 6, detect the CO content in the vehicle, and alarm when the CO concentration exceeds a safety level.

In a further embodiment, the power supply device for emergency starting according to the invention further provides a warning light function, and in that case, the control unit can also control the warning light 7.

In a further embodiment, a control unit controls a display unit such as a display screen to display information such as present electric quantity of the battery.

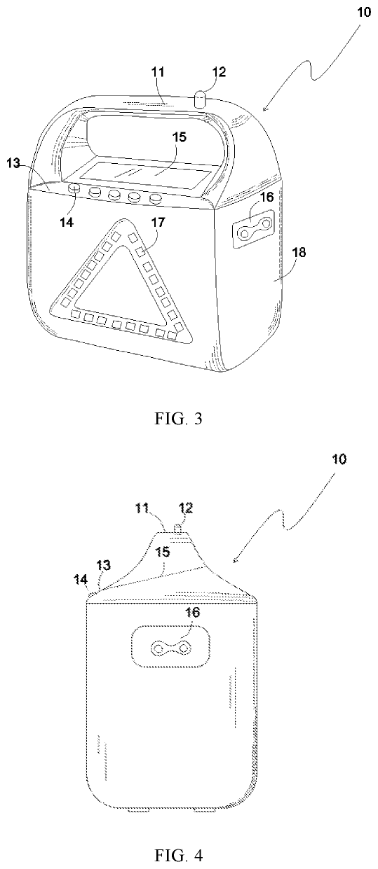

A perspective and side view of one embodiment of a power supply device for vehicle emergency are shown as FIG. 3 and FIG. 4. As illustrated in the drawings, the power supply device 10 comprises a body 18. A handle 11 connected with the body 18 is arranged above the body 18. A display screen 15 is provided on the body 15 under the handle 11 for displaying related information such as battery power, CO concentration and warning light status. The display screen 15 is arranged obliquely with respect to the horizontal plane. Since the power supply device 10 is generally used outdoors, the display screen 15 obliquely arranged under the handle 11 can be shadowed from outdoor light rays so as not to influence the display effect. A control panel 13 is provided on one side of the display screen 15, and buttons 14 are provided on the control panel 13. A output port 16 is provided on one side of the body.

In this embodiment, a CO sensor 12 is provided on the handle 11 and enables the power supply device 10 to detect and alarm CO concentration in a vehicle.

In this embodiment, a warning triangle of light composed of yellow light-emitting diodes 17 is provided on the front face of the body 15. When a vehicle fails on road, the driver can illuminate the warning light to warn the drivers in the vehicles behind. The warning light can also be used together with a reflecting warning triangle.

Protection switch 2 may be a relay, or other electronic switches.

The built-in battery 1 may be a lead-acid battery, a lithium-ion battery or other energy storage device such as a super capacitor.

For a 24V vehicle, the voltage of the emergency start power supply is between 24V-32V.

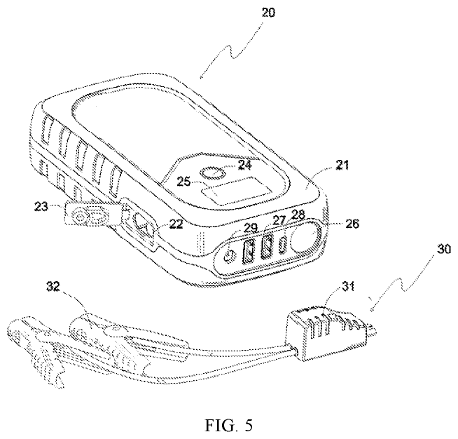

FIG. 5 illustrates another embodiment in accordance with the present invention. The power supply device for vehicle emergency starting 20 has a cuboid type with smooth transition at corners, and a built-in battery. An output port 22 is provided on the side of the power supply device 20, and a sealing cover 23 is arranged outside the output port 22. A switch button 24 is provided on the front side of the power supply device 20. A power display screen 25 is arranged beside the switch button 24. A flashlight lamp 26, a Type C charging port 28, a USB port 27, and a 12V output end 29 are provided on the end face of the power supply device 20.

An electrical connection cable 30 for use with the power supply device 20 includes a plug 31 that mates with the output port 22, and clips 32 that can be clamped on the accumulator electrodes.

The foregoing detailed description describes preferred embodiments of the invention. It should be understood that many modifications and variations can be made in accordance with the concepts of the present invention without creative efforts by those of ordinary skill in the art. Accordingly, all the modifications and alterations of the device and method made by those skilled in the art without departing from the spirit shall be deemed as still within the scope of the invention as defined by the appended claims.

1. A power supply device for vehicle emergency starting is characterized by comprising a built-in battery, a protection switch, and a control unit, wherein the control unit is configured to receive vehicle ignition signal, and the control unit is configured to close the protection switch when the vehicle ignition signal is received after the power supply device is connected to the accumulator of the vehicle.

2. The power supply device for vehicle emergency starting as claimed in claim 1, wherein the vehicle ignition signal is derived from a sudden change of voltage or current at the terminals of the accumulator of the vehicle.

3. The power supply device for vehicle emergency starting as claimed in claim 1, wherein the vehicle ignition signal is derived from vehicle central control system.

4. The power supply device for vehicle emergency starting as claimed in claim 2, wherein the power supply device comprises a body and a handle; a screen is obliquely disposed under the handle portion on the body.

5. The power supply device for vehicle emergency starting as claimed in claim 4, wherein a CO sensor and a CO alarm device are provided on the handle.

6. The power supply device for vehicle emergency starting as claimed in claim 5, wherein a warning triangle of light composed of yellow light-emitting diodes is provided on the front face of the body.

7. A method for vehicle emergency starting is characterized by comprising steps:
connecting the accumulator of the vehicle to a power supply device, wherein the power supply device includes a built-in battery, a protection switch and a control unit;
igniting the vehicle;
the control unit closing the protection switch when it receives vehicle ignition signal, thereby the built-in battery supplying power to the accumulator to start the vehicle.

8. The method for vehicle emergency starting as claimed in claim 7, wherein the vehicle ignition signal is derived from a sudden change of voltage or current at the terminals of the accumulator of the vehicle.

9. The method for vehicle emergency starting as claimed in claim 7, wherein the vehicle ignition signal is derived from vehicle central control system.

10. The method for vehicle emergency starting as claimed in claim 8, wherein the power supply device comprises a body and a handle; a screen is obliquely disposed under the handle portion on the body; a CO sensor and a CO alarm device are provided on the handle; a warning triangle of light composed of yellow light-emitting diodes is provided on the front face of the body.
